(19) United States
(12) Patent Application Publication
(10) Pub. No.: US 2011/0164988 A1
(43) Pub. Date: Jul. 7, 2011

(54) TURBOCHARGER AND COMPRESSOR IMPELLER THEREFOR

(75) Inventors: Gerald Schall, Bobenheim-Roxheim (DE); Melanie Gabel, Bad Duerkheim (DE)

(73) Assignee: BORGWARNER INC., Auburn Hills, MI (US)

(21) Appl. No.: 13/062,731

(22) PCT Filed: Sep. 21, 2009
(86) PCT No.: PCT/US09/57641

§ 371 Date: Mar. 8, 2011

(30) Foreign Application Priority Data
Sep. 25, 2008 (DE) 10 2008 048 886.0

(51) Int. Cl. F01D 5/14; B05D 1/02; B05D 7/00

(52) U.S. Cl. 416/241 R; 427/422

(57) ABSTRACT

The invention relates to a compressor impeller for a turbocharger, in particular in a diesel engine, and to an exhaust gas turbocharger containing such a compressor impeller.

The invention relates to a compressor impeller for a turbocharger, particularly in a diesel engine, according to the preamble of claim 1, to an exhaust gas turbocharger with a compressor impeller, according to the preamble of claim 7, and also to a method for producing the compressor impeller according to the invention, according to the preamble of claim 12.

Exhaust gas turbochargers are systems for increasing the power of piston engines. In an exhaust gas turbocharger, the energy of the exhaust gases is utilized in order to increase the power. The power increase results from a rise in the mixture throughput per working stroke.

A turbocharger consists essentially of an exhaust gas turbine with a shaft and a compressor impeller, the compressor arranged in the intake tract of the engine being connected to the shaft, and the blade wheels located in the casing of the exhaust gas turbine and in the compressor impeller rotating.

Exhaust gas turbochargers are known which allow multistage, that is to say at least two-stage, supercharging, so that even more power can be generated from the exhaust gas. Such multistage exhaust gas turbochargers have a special set-up which comprises a regulating member for highly dynamic cyclic stresses, which comprises, for example, a flap dish, a lever or a spindle.

The compressor impeller in the exhaust gas turbocharger has to satisfy extremely stringent material requirements. The material from which the compressor impeller is formed must be heat-resistant, that is to say still afford sufficient strength even at high temperatures of at least up to about 280° C. Furthermore, the material must be resistant to intercrystalline corrosion and stress crack formation in the acid medium, and, moreover, it should have high material resistance, along with a low stress cycle coefficient. Furthermore, the ductility of the material should be sufficiently high so that, in the event of overload, the parts can experience plastic deformation and do not break, the result of this being that a sudden release of energy and damage resulting from this are possible.

An exhaust gas turbocharger with a double-flow exhaust gas inlet duct is known from DE 10 2007 018 617 A1.

The object of the present invention, then, was to provide a compressor impeller for a turbocharger, according to the preamble of claim 1, and a turbocharger according to the preamble of claim 7, which has improved heat resistance and temperature resistance and is distinguished by a good resistance to corrosion and stress crack formation in acid media. Furthermore, the material should have optimal ductility and an improved oscillation fatigue strength performance. A wear-resistant and permanently stable compressor impeller is consequently to be capable of being produced. Furthermore, the object was to provide a method for producing the compressor impeller according to the invention, a material being produced which is distinguished by the above-mentioned advantageous properties.

The objects are achieved by means of the features of claims 1, 7 and 13.

Owing to the design according to the invention of the compressor impeller for a turbocharger, consisting of an aluminum-based alloy with dendritic precipitation phases, which contains dispersions of the elements lanthanum and zirconium, what is achieved is that the material which ultimately provides the compressor impeller in the exhaust gas turbocharger is distinguished by particularly good heat resistance, temperature resistance and stability. The stability and temperature resistance of the material according to the invention are achieved particularly in that the dendritic precipitation phases form a high ramification in the material due to the interaction of the intermetallic phases. The high ramification of the intermetallic phases in the microstructure of the material is critical for the supporting action of the microstructure and therefore also for resistance to lattice slip, with the result that the material becomes consolidated and is resistant to both static and cyclic mechanical load. Owing to the specific material combination for the compressor impeller according to the invention, moreover, the adhesive and cohesive forces in the material matrix are increased. It was found that a combination of the elements lanthanum and zirconium in the aluminum-based alloys is essential for the stability of the material. The combination of these elements in the alloy leads to a very high stability of the material, since a particularly good microstructure is formed by means of the dendritic ramifications.

It was found, furthermore, that lanthanum in an aluminum-based alloy gives rise to a markedly strength-enhancing action both at room temperature and at component temperatures of up to 280° C. It is presumed that thermally stable Al₃La phases are formed, which also exert a positive action with respect to the creep resistance of the material. Lanthanum consequently increases the heat resistance and also resistance to material fatigue in the case of low stress cycle coefficients and, consequently, the stability of the material according to the invention for the compressor impeller.

The element zirconium also forms phases in the alloy, to be precise Al₃Zr phases, with the result that a cross-linking structure, what is known as a chaining characteristic, is achieved in the microstructure. It was found that precipitation phases are formed within the alloy material due to the combination of aluminum and zirconium. The mechanical properties of the material are thereby significantly improved. A material thus formed or a component formed from just such a material is distinguished by very good temperature resistance and heat resistance up to 280° C., is stable to corrosion and is insensitive to stress crack formation.

However, it is exactly the combination of the elements zirconium and lanthanum in the aluminum-based alloy which is essential for providing material for the compressor impeller according to the invention which, due to the formation of fine strong ramifications of the intermetallic phases, has very good material resistance in the case of a low stress cycle coefficient and exhibits high heat resistance up to 280° C. and, furthermore, a ductility sufficient for such a material. Without being involved in theory, it is presumed that the combination of the elements lanthanum and zirconium in the aluminum-based alloy affords an extremely stable highly heat-resistant material and, consequently, component exactly because the Al₃La phases or Al₃Zr phases which form in the microstructure structures which encroach one upon the other and which, because of their structural similarity to one another, give rise to an improved bond within the material.

Furthermore, it was shown that the compressor impeller according to the invention, produced from the material just described, is resistant to corrosion and stress crack formation even in acid media. An acid media in the context of the invention is in this case to be understood as meaning a medium which has a pH value of about 3.5 to 6 and, in particular, of about 4 to 5.5.

Owing to condensation water and chlorides from the surroundings of the engine space, “acid” conditions also prevail in the exhaust gas turbocharger. The material according to the invention is resistant to this and therefore also resistant to intercrystalline corrosion. The tendency to stress crack formation under tensile stress is thereby markedly reduced.

Owing to these outstanding material properties, the compressor impeller according to the invention for an exhaust gas turbocharger is also suitable particularly for two-stage turbochargers and most particularly for those which are used in motor trucks and here, in particular, for highly cyclic bus applications which have a high running performance of up to 1.6 million running kilometers in the field.

The subclaims contain advantageous developments of the invention.

In a preferred embodiment, the aluminum-based alloy contains the elements lanthanum and zirconium with a content of 0.08 to 1.0% by weight and more preferably of 0.2 to 0.5% by weight for lanthanum and 0.35 to 8% by weight and more preferably 1 to 5% by weight for zirconium in relation to the overall weight of the alloy. Zirconium is essential for the occurrence and distribution of the precipitation phases in the aluminum-based alloy. As already stated, aluminum in this case forms with the zirconium Al₃Zr phases which are precipitated separately and bring about an additional stabilization of the material also with respect to the heat resistance and oscillation fatigue strength of the alloy and, consequently, of the compressor impeller according to the invention. These important material properties come into particularly sharp focus when the quantitative fraction of zirconium is in a range of 1 to 5% by weight in relation to the overall weight of the alloy. A high contact of zirconium, in other words a content of more than 8% by weight in relation to the alloy, leads, in turn, to a lowering of the heat resistance of the material, along with a lower long-time rupture strength.

Additions of lanthanum to the aluminum-based alloy increase the strength of the material and consequently of the component. As already stated, lanthanum too forms with aluminum Al₃La phases which are precipitated separately and which, moreover, have a positive influence on the creep resistance of the material. At the same time, with the introduction of these phases, the heat resistance of the material rises, and the resistance to material fatigue in the case of a low stress cycle coefficient is improved. This is the case particularly when lanthanum is employed in a quantitative fraction of 0.08 to 1.0% by weight and particularly preferably in a quantitative fraction of 0.2 to 0.5% by weight in relation to the overall weight of the aluminum-based alloy. As already stated, it is exactly the combination of lanthanum and zirconium in the aluminum-based alloy which is important for achieving the stability parameters of the material which were described above. A content of more than 1% by weight of lanthanum in the alloy leads to a reduction in the heat resistance and, furthermore, reduces the long-time rupture strength.

The physical and mechanical properties of the material and consequently of the compressor impeller can be optimized even further. In a preferred embodiment, the compressor impeller according to the invention is distinguished in that the aluminum-based alloy contains further elements, such as iron and/or manganese and/or vanadium and/or nickel and/or niobium and/or scandium. The property profile of each element is basically known to a person skilled in the art.

For example, an admixture of the elements manganese and iron to an alloy contributes to increasing the heat resistance of the material due to the formation of dispersoid phases on account of their chaining properties. It is particularly advantageous for this purpose if the iron content is in a range of 1 to 15% by weight and preferably 3 to 11% by weight in relation to the overall weight of the alloy, and the manganese content is 1 to 12% by weight and preferably 3 to 9.5% by weight in relation to the overall weight of the alloy.

The addition of vanadium to an alloy usually leads to an improvement in the grain distribution of the intermetallic composition. Vanadium at the same time has a consolidating action on the dispersoid precipitations here in the overall composite alloy structure. Vanadium increases the adhesive and cohesive forces in the microstructure of the material and therefore stabilizes the structure produced. Preferably, vanadium is used in a content of 0.5 to 8% by weight in relation to the overall weight of the alloy and particularly preferably in a content of 1.5 to 6% by weight in relation to the overall weight of the alloy. In this concentration range, vanadium brings about a particularly pronounced improvement in adhesion and cohesion in the alloy structure and therefore contributes considerably to optimizing the stability of the compressor impeller according to the invention.

The element nickel is an element which likewise exerts an appreciable influence on the heat resistance of the compressor impeller according to the invention. It is exactly the combination of aluminum and nickel which in this case decisively increases the adhesive and cohesive forces of the material, particularly also in the acid medium, that is to say in a pH range of 3.5 to and preferably of 4 to 5.5. Preferably, nickel is used with a content of 1 to 14% by weight in relation to the overall weight of the alloy and particularly preferably with a content of 3 to 10% by weight in relation to the overall weight of the alloy. The properties improving the stability in the acid pH range come into particularly sharp focus here.

Niobium is an element, the use of which in aluminum-based alloys is unusual. It was found, then, that niobium, like zirconium, optimizes the occurrence and distribution of the precipitation phases in the alloy. As a result, the mechanical properties both at room temperature and in a temperature range of up to 280° C. are influenced positively. The material for the compressor impeller according to the invention is therefore distinguished by a heat resistance of up to 280° C. Furthermore, the creep resistance and the oscillation fatigue strength of the alloy are also improved by a multiple. Preferably, niobium is used with a content of 0.5 to 8% by weight and particularly preferably with a content of 1.5 to 6% by weight in relation to the overall weight of the alloy. In this concentration range, niobium contributes particularly highly to the increase in the heat resistance and oscillation fatigue strength of the compressor impeller according to the invention.

Scandium has a similar action on alloy materials to lanthanum. It contributes to increasing strength of the material. It was found that scandium, too, forms special phases with aluminum, to be precise Al₃Sc precipitation hardening phases which likewise have a positive effect on the creep resistance or creep strength of the material. Moreover, the heat resistance is also increased, and, furthermore, also the resistance to material fatigue in the case of low stress cycle coefficients. The preferred actions come into particular focus when scandium is used in a quantitative fraction of 0.05 to 1.0% by weight and preferably in a quantitative fraction of 0.1 to 0.4% by weight in relation to the overall weight of the aluminum-based alloy.

In a Particularly advantageous embodiment, a combination of the elements lanthanum and scandium is used in the aluminum-based alloy, the aluminum-based alloy containing the elements lanthanum and scandium in a total fraction of 0.13 to 2.0% by weight and preferably of 0.3 to 0.9% by weight in relation to the overall weight of the alloy. It is precisely then that the material is distinguished by particularly high heat resistance and resistance to material fatigue in the case of low stress cycle coefficients.

In a further advantageous embodiment, the compressor impeller according to the invention is distinguished by an aluminum-based alloy which contains, furthermore, the following elements or components with the following quantitative fractions, the quantitative fractions in each case relating to the overall weight of the alloy: Fe: 1 to 15% by weight, Mn: 1 to 12% by weight, Nb: 0.5 to 8% by weight, V: 0.5 to 8% by weight, Ni: 1 to 14% by weight, Zr: 0.35 to 8% by weight, the sum of La and Sc: 0.13 to 2.0% by weight, and Al. It is exactly the combination of these elements in the quantitative fractions given which leads to a material which, when processed into a compressor impeller for an exhaust gas turbocharger, gives this particularly high stability with respect to corrosion and, furthermore, is distinguished by very good heat resistance and resistance to material fatigue in the case of a low stress cycle coefficient. The compressor impeller exhibits improved creep strength and an excellent oscillation fatigue strength performance. The abovementioned properties come into particular focus when the compressor impeller according to the invention contains the following elements in the quantitative fractions given: Fe: 3 to 11% by weight, Mn: 3 to 9.5% by weight, Nb: 1.5 to 6% by weight, V: 1.5 to 6% by weight, Ni: 3 to 10% by weight, Zr: 1 to 5% by weight, the sum of La and Sc: 0.3 to 0.9% by weight, in each case in relation to the overall weight of the alloy, and Al.

A compressor impeller consisting of an aluminum-based alloy containing the abovementioned elements is distinguished by particularly good properties.

Thus, a material produced according to the last-mentioned specific compositions has the following properties:

| Mechanical property | Value | | Measurement method |
|---|---|---|---|
| Tensile strength Rₘ | >600 | MPa | ASTM E 8M/EN 10002-1; |
| | | | at increased |
| | | | temperature: EN 10002-5 |
| Yield point R_{p 0.2} | >500 | MPa | Standard method |
| Elongation at break | >5% | | Standard method |
| Hardness | 160-205 | HB | ASTM E 92/ISO 6507-1 |
| Coefficient of | 16-19 1/K (20 | | Standard method |
| elongation | to 900° C.) | | |
| Density | >2.95 | g/cm³ | Standard method |

To determine the stability of the material, the following tests were conducted:
outdoor exposure tests
tensile tests under heat up to 300° C.
creep strength up to 300° C.
changing climate in an acid medium: 150 hours at pH 4 to 5.5
LCF test: 2 000 000 cycles at 220° C., amplitude: 170 MPa.

The oscillation fatigue strength tests were conducted exclusively under single-stage axial pulsating load with force regulation (R=0). The ambient medium was air. The material was investigated (material temperature) in a temperature interval from room temperature (that is to say, about 20° C.) up to 220° C.

A most particularly preferred alloy is obtained from the elements listed below: Fe: 3 to 5.3% by weight, Mn: 3.2 to 5.3% by weight, Nb: 1.8 to 3.2% by weight, V: 1.5 to 3.3% by weight, Ni: 3.7 to 5.8% by weight, Zr: 1 to by weight, La: 0.1 to 0.4% by weight and Sc: 0.05 to 0.3 by weight, in each case in relation to the overall weight of the alloy, and Al.

This aluminum-based alloy according to the invention exhibited the best results in the above tests.

According to the invention, the aluminum-based alloy, on which the compressor impeller according to the invention for a turbocharger is based, can be produced by means of suitable methods and, in particular, by means of a spray-compacted method still to be carried out. The respective materials are weldable by means of conventional WIG plasma methods and also EB methods. Heat treatment takes place by solution annealing at about 640° C. for 2 hours and with subsequent air cooling. Precipitation hardening takes place at about 250° C. for 2 hours, with air cooling, in a box furnace.

The processing of the aluminum-based alloy takes place according to conventional processes by the fusion of the basic alloy, RS spraying, precompaction (densal HIP treatment), extrusion, forming and further machining (for example, milling).

Claim 7 defines as an independently handlable article an exhaust gas turbocharger which, as already described, comprises a compressor impeller which consists of an aluminum-based alloy with dendritic precipitation phases and which contains dispersions of the elements lanthanum and zirconium.

The compressor impeller according to the invention is produced by means of a special method which comprises the following steps:
introduction of a fused material consisting of an aluminum-based alloy as claimed in one of claims 1 to 6 into a special crucible,
transfer of the fused material into an admission vessel with the following “atomizer”, and
fine spraying of the fused material under a protective gas atmosphere on a rotating disk.

Only in this way is an alloy material obtained which, after further machining, provides a compressor impeller which is distinguished by extremely good resistance to corrosion and stress crack formation, has a heat resistance up to 280° C., and exhibits a markedly reduced material fatigue frequency in the case of a low stress cycle coefficient and a very good oscillation fatigue strength performance. It was found that, by virtue of the method according to the invention, a very fine-grained, even dispersoid powder formation can be processed in the run-up. In this case, various grain sizes of the individual elements can be defined, and this can additionally bring about a highly improved creep strength and a good oscillation fatigue performance.

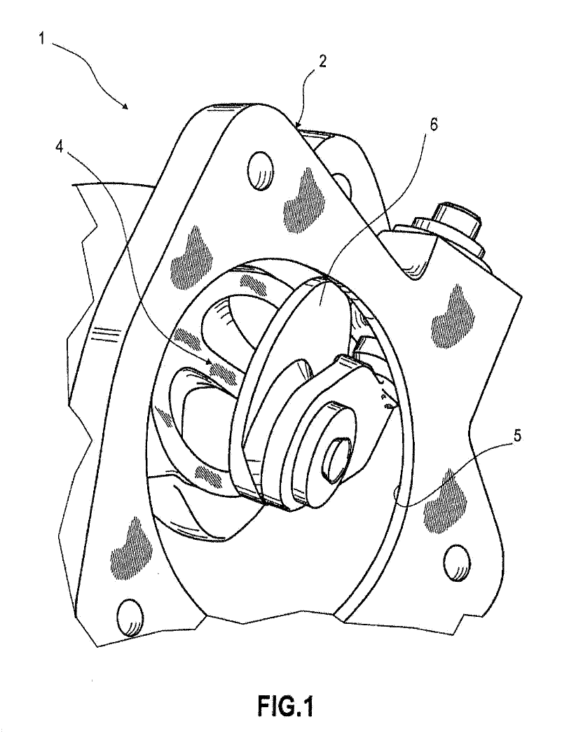

FIG. 1 shows a partial illustration of an embodiment of the turbocharger 1 according to the invention which does not need to be described in any more detail with regard to the compressor, the compressor casing, the compressor shaft, the bearing casing and the bearing arrangement and also all other conventional parts. The exhaust gas inlet duct cannot be seen here. The exhaust gas inlet duct is provided with a double-flow bypass duct 4 which branches off from the exhaust gas inlet duct and which leads to an exhaust gas outlet 5 of the turbine casing 2. The bypass duct 4 has a regulating flap 6 for opening and closing.

### LIST OF REFERENCE SYMBOLS

1 Turbocharger
2 Turbine casing
4 Bypass duct
5 Exhaust gas outlet
6 Regulating flap/wastegate flap

1. A compressor impeller for a turbocharger, in particular for a diesel engine, consisting of an aluminum-based alloy with dendritic precipitation phases which alloy contains dispersions of the elements lanthanum and zirconium.

2. The compressor impeller as claimed in claim 1, wherein the aluminum-based alloy contains the elements lanthanum in a quantitative fraction of 0.08 to 1.0% by weight and preferably of 0.2 to 0.5% by weight and zirconium in a quantitative fraction of 0.35 to 8% by weight and preferably of 1 to 5% by weight in relation to the overall weight of the alloy.

3. The compressor impeller as claimed in claim 1, wherein the aluminum-based alloy contains iron and/or manganese and/or vanadium and/or nickel and/or niobium and/or scandium.

4. The compressor impeller as claimed in claim 1, wherein the aluminum-based alloy contains the elements lanthanum and scandium, their total fraction amounting to 0.13 to 2.0% by weight in relation to the overall weight of the alloy.

5. The compressor impeller as claimed in claim 1, wherein the aluminum-based alloy contains the following components: Fe: 1 to 15% by weight, Mn: 1 to 12% by weight, Nb: 0.5 to 8% by weight, V: 0.5 to 8% by weight, Ni: 1 to 14% by weight, Zr: 0.35 to 8% by weight, the sum of La and Sc: 0.13 to 2.0% by weight, in each case in relation to the overall weight of the alloy, and Al.

6. The compressor impeller as claimed in claim 1, wherein the aluminum-based alloy contains the following components: Fe: 3 to 11% by weight, Mn: 3 to 9.5% by weight, Nb: 1.5 to 6% by weight, V: 1.5 to 6% by weight, Ni: 3 to 10% by weight, Zr: 1 to 5% by weight, the sum of La and Sc: 0.3 to 0.9% by weight, in each case in relation to the overall weight of the alloy, and Al.

7. An exhaust gas turbocharger, in particular for diesel engines, comprising a compressor impeller consisting of an aluminum-based alloy with dendritic precipitation phases which alloy contains dispersions of the elements lanthanum and zirconium.

8. The exhaust gas turbocharger as claimed in claim 7, wherein the aluminum-based alloy contains the elements lanthanum in a quantitative fraction of 0.08 to 1.0% by weight and preferably of 0.2 to 0.5% by weight and zirconium in a quantitative fraction of 0.35 to 8% by weight and preferably of 1 to 5% by weight in relation to the overall weight of the alloy.

9. The exhaust gas turbocharger as claimed in claim 7, wherein the aluminum-based alloy contains iron and/or manganese and/or vanadium and/or nickel and/or niobium and/or scandium.

10. The exhaust gas turbocharger as claimed in claim 7, wherein the aluminum-based alloy contains the elements lanthanum and scandium, their total fraction amounting to 0.13 to 2.0% by weight in relation to the overall weight of the alloy.

11. The exhaust gas turbocharger as claimed in claim 7, wherein the aluminum-based alloy contains the following components: Fe: 1 to 15% by weight, Mn: 1 to 12% by weight, Nb: 0.5 to 8% by weight, V: 0.5 to 8% by weight, Ni: 1 to 14% by weight, Zr: 0.35 to 8% by weight, the sum of La and Sc: 0.13 to 2.0% by weight, and Al.

12. The exhaust gas turbocharger as claimed in claim 7, wherein the aluminum-based alloy contains the following components: Fe: 3 to 11% by weight, Mn: 3 to 9.5 by weight, Nb: 1.5 to 6% by weight, V: 1.5 to 6% by weight, Ni: 3 to 10% by weight, Zr: 1 to 5% by weight, the sum of La and Sc: 0.3 to 0.9% by weight, and Al.

13. A method for producing a compressor impeller, comprising the steps:
introduction of a fused material consisting of an aluminum-based alloy as claimed in one of claims 1 to 6 into a special crucible,
transferring the fused material into an admission vessel with a following “atomizer” and
fine spraying of the fused material under a protective gas atmosphere on a rotating disk.
